(19) United States
(12) Patent Application Publication
(10) Pub. No.: US 2026/0288378 A1
(43) Pub. Date: Sep. 24, 2026

(54) METHOD, AND APPARATUS FOR PERFORMING DATA TRANSFER IN SSD BY CAPITALIZING ON CONSECUTIVE PRP LIST

(71) Applicant: SAMSUNG ELECTRONICS CO., LTD., Suwon-si (KR)

(72) Inventors: Sreenivasa REDDY, Karnataka (IN); Venkataratnam NIMMAGADDA, Karnataka (IN); Anuj Kumar SINGH, Karnataka (IN); Kaushal KISHOR YADAV, Karnataka (IN); Ojesh DUGAR, Karnataka (IN)

(73) Assignee: SAMSUNG ELECTRONICS CO., LTD., Suwon-si (KR)

(21) Appl. No.: 19/275,493

(22) Filed: Jul. 21, 2025

(30) Foreign Application Priority Data
Mar. 19, 2025 (IN) 202541024888
Jul. 7, 2025 (IN) 202541024888

(51) Int. Cl. G06F 3/06

(52) U.S. Cl. CPC G06F 3/0659; G06F 3/0604; G06F 3/0679

(57) ABSTRACT

The present disclosure provides method and apparatus for performing data transfer in an SSD. The method includes configuring, by a host, a designated bit in a Non-Volatile Memory Express (NVMe) command to indicate a contiguous state or a non-contiguous state of a first Physical Region Page (PRP) list and a second PRP list among a plurality of PRP lists; and transmitting, by the host, the NVMe command for a controller of the SSD to perform data transfer in the SSD based on the designated bit.

### CROSS-REFERENCES TO RELATED APPLICATION(S)

The present application claims priority from Indian Provisional Patent Application No. 202541024888, filed on Mar. 19, 2025, and Indian Patent Application No. 202541024888, filed on Jul. 7, 2025, in the Indian Intellectual Property Office and all the benefits accruing therefrom under 35 U.S.C. 119, the contents of which are incorporated herein by reference in their entireties.

### BACKGROUND

The present disclosure is related to the field of data storage, more particularly, to data transfer in Solid-State Drive (SSD) by capitalizing on consecutive Physical Region Page (PRP) list.

Storage devices such as SSDs are used to store data. PRPs are used for transferring data between a host and an SSD. A Physical Region Page (PRP) list is a set of PRP entries in a single page of contiguous memory. If an amount of data to be transferred requires multiple PRP list memory pages, then the last PRP entry in a memory page shall be a pointer to a next PRP list, indicating the next segment of the PRP list.

In related art, irrespective of whether PRP lists are contiguous or non-contiguous, the last entry in the PRP list always represents the pointer to the next PRP list. In this mechanism, a controller of an SSD reads one extra entry (i.e., the last entry in the PRP list) to process the next PRP list. This additional read mechanism to locate the next PRP list is extraneous if the next PRP list is contiguous. Additionally, data read from a host memory is expensive. Specifically, when controllers have less Static Random-Access Memory (SRAM) for PRP buffers, reading PRP entries creates bubbles or gaps (between PRP lists), which increases Peripheral Component Interconnect Express (PCIe) transactions. These additional transactions can significantly affect controller's performance.

The information disclosed in this background of the disclosure section is only for enhancement of understanding of the general background of the disclosure and should not be taken as an acknowledgement or any form of suggestion that this information forms the prior art already known to a person of ordinary skill in the art.

### SUMMARY

In some example embodiments, the present disclosure relates to a method for performing data transfer in an SSD by a host. The method includes configuring, by a host, a designated bit in a Non-Volatile Memory Express (NVMe) command to indicate a contiguous state or a non-contiguous state of a first Physical Region Page (PRP) list and a second PRP list among a plurality of PRP lists; and transmitting, by the host, the NVMe command for a controller of the SSD to perform data transfer in the SSD based on the designated bit.

In some example embodiments, the present disclosure relates to a method for performing data transfer in an SSD by a controller of an SSD. The method includes accessing, by the controller of the SSD, a Non-Volatile Memory Express (NVMe) command transmitted by a host; and processing, by the controller, a first Physical Region Page (PRP) list and a second PRP list based on a configuration of a designated bit in the NVMe command indicating a contiguous state or a non-contiguous state of the first PRP list and the second PRP list, the first PRP list and the second PRP list being among a plurality of PRP lists.

In some example embodiments, the present disclosure relates to a host. The host comprises at least one processor and a memory communicatively coupled to the processor. The wherein the memory stores processor-executable instructions, which on execution, cause the at least one processor to configure a designated bit in a Non-Volatile Memory Express (NVMe) command to indicate a contiguous state or a non-contiguous state of a first Physical Region Page (PRP) list and a second PRP list among a plurality of PRP lists; and fetching, by the controller, a data from the data buffer by accessing the second PRP list based on the calculation.

In some example embodiments, the present disclosure relates to a controller of an SSD. The controller comprises at least one processor and a memory communicatively coupled to the at least one processor. The memory stores processor-executable instructions, which on execution, cause the at least one processor to configure a designated bit in a Non-Volatile Memory Express (NVMe) command to indicate a contiguous state or a non-contiguous state of a first Physical Region Page (PRP) list and a second PRP list among a plurality of PRP lists; and transmit the NVMe command for a controller of the SSD to perform data transfer in the SSD based on the designated bit.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The accompanying drawings, which are incorporated in and constitute a part of this disclosure, illustrate some example embodiments and together with the description, serve to explain the disclosed principles. In the figures, the left-most digit(s) of a reference number identifies the figure in which the reference number first appears. The same numbers are used throughout the figures to reference like features and components. Some example embodiments of device and/or methods in accordance with embodiments of the present subject matter are now described below, by way of example only, and with reference to the accompanying figures.

FIG. 1A illustrates an environment for performing data transfer in an SSD in accordance with some example embodiments of the present disclosure.

FIG. 1B illustrates an example configuration of a designated bit in a NVMe command in accordance with some example embodiments of the present disclosure.

FIGS. 1C to 1E illustrate examples configuration of a designated bit in a last entry in a current PRP list of the plurality of PRP lists in accordance with some example embodiments of the present disclosure.

FIG. 2A shows a detailed block diagram of a host in accordance with some example embodiments of the present disclosure.

FIG. 2B shows a detailed block diagram of a controller of an SSD in accordance with some example embodiments of the present disclosure.

FIGS. 3A and 3B illustrate flowcharts showing processes for performing data transfer in an SSD in accordance with some embodiments of the present disclosure.

It should be appreciated by those of ordinary skill in the art that any block diagrams herein represent conceptual views of illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

While the disclosure is susceptible to various modifications and alternative forms, specific embodiments thereof have been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a system, device, non-transitory computer readable medium, and/or method that comprises a list of components or operations does not include only those components or operations but may include other components or operations not expressly listed or inherent to such setup or device or method. In other words, one or more elements in a system or apparatus proceeded by “comprises . . . a” does not, without more constraints, preclude the existence of other elements and/or additional elements in the system or method.

In the following detailed description of some example embodiments of the disclosure, reference is made to the accompanying drawings that form a part hereof, and in which are shown by way of illustration specific embodiments in which the disclosure may be practiced. These example embodiments are described in sufficient detail to enable those of ordinary skill in the art to practice the disclosure, and it is to be understood that other embodiments may be utilized and that changes may be made without departing from the scope of the present disclosure. The following description is, therefore, not to be taken in a limiting sense.

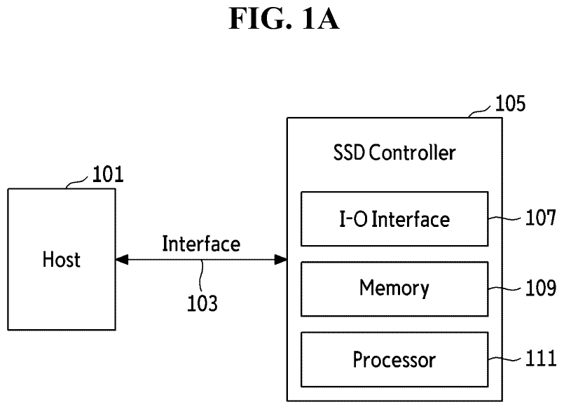

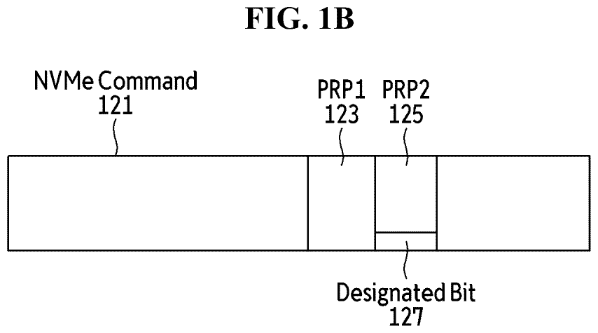

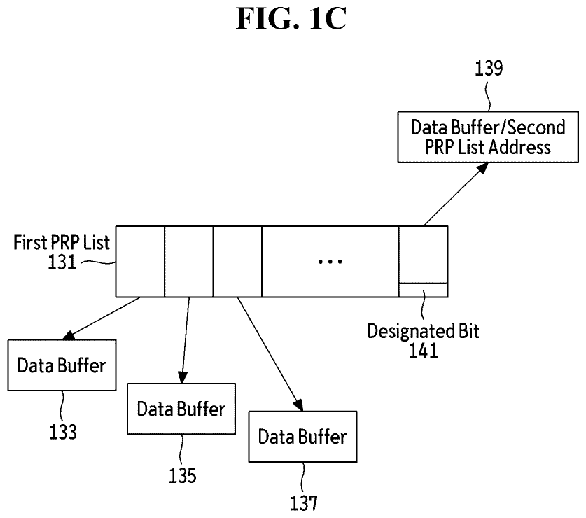

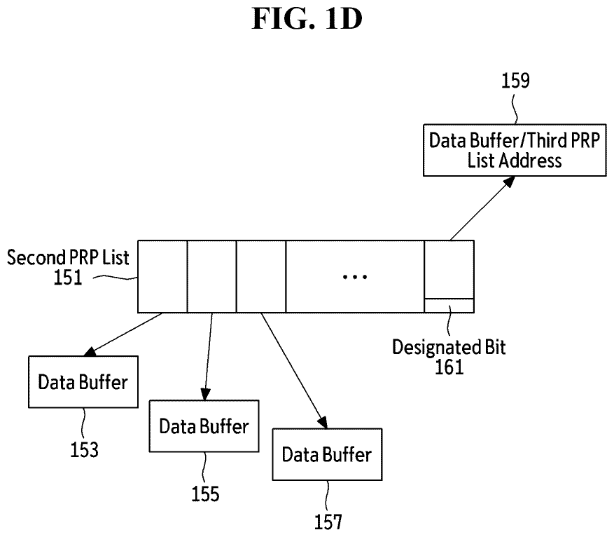

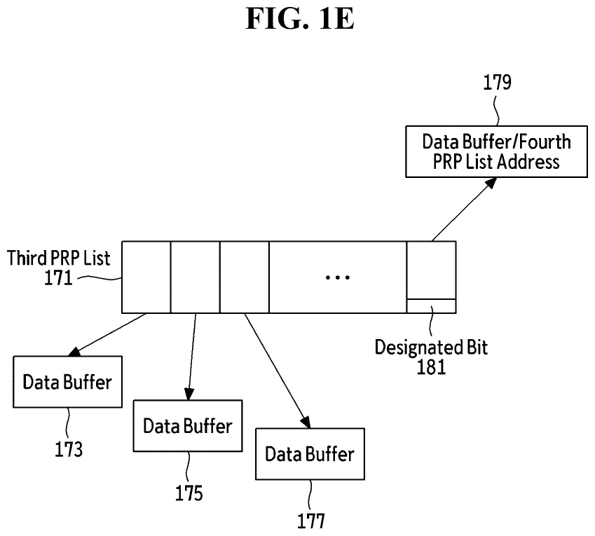

FIG. 1A illustrates an environment for performing data transfer in an SSD in accordance with some example embodiments of the present disclosure.

In FIG. 1A, the environment includes a host (also, referred as a host device) 101, an interface 103, and a controller of an SSD (also, referred as an SSD controller, may include more than one controller) 105. The host 101 can be a computer, a laptop, a mobile device, an embedded device, or any computing device. The host 101 is connected to the controller 105 via the interface 103. The interface 103 may be a wired communication.

In some example embodiments, the SSD may be a NAND based device. The controller 105 includes an Input-Output (I-O) interface 107 (for example, a communication interface), a memory 109, and a processor 111. The I-O interface 107 may be configured to receive an I-O (also, referred as I-O request) from the host 101. The I-O (or I-O request) may be a read request (also, referred as a data read request) or a write request (also, referred as a data write request). The I-O interface 107 employs a wired communication protocol/method.

The memory 109 may be communicatively coupled to the processor 111 of the controller 105. The memory 109, also, stores controller-executable instructions which may cause the processor 111 to execute the instructions for performing data transfer in the SSD. The memory 109 includes, without limitation, memory drives, removable disc drives, etc.

The processor 111 includes at least one data processor for performing data transfer in the SSD. The processor 111 may include specialized processing units such as integrated system (bus) controllers, memory management control units, floating point units, graphics processing units, digital signal processing units, etc.

Hereinafter, the operation for performing data transfer in the SSD is explained with reference to FIGS. 1B to 1E.

A NVMe command 121 (also, referred as NVMe command entry or NVMe Submission Queue) is used for communication with an SSD. The NVMe command 121 includes PRP1 and PRP2 as two specific fields. The PRP1 of the NVMe command 121 may store a memory address pointing to a data buffer. The data buffer may be of a limited size, for example, 4 KB. When data buffer requirement is more than, for example, 4 KB, then NVMe protocol allows usage of the PRP2. The PRP2 of the NVMe command 121 may store a memory address pointing to another data buffer. The PRP1 and PRP2 used together allows utilizing data buffer up to 8 KB (i.e., 4 KB addressed by PRP1 and 4 KB addressed by PRP2). However, if data buffer requirement is more than, for example, 8 KB, the NVMe protocol allows PRP2 to point to a PRP list. The PRP list is a set of PRP entries in a single page of contiguous memory. The PRP list comprises a list of pointers where each pointer points to a separate data buffer, as shown in FIGS. 1C to 1E.

Consider the host 101 wants to write data in the SSD. Prior to sending a write request or submitting the NVMe command 121 for the controller 105 to perform data transfer in the SSD, the host 101 may configure a designated bit 127 in the NVMe command 121, as shown in FIG. 1B. The designated bit 127 may be a single bit in the PRP2 of the NVMe command 121. The designated bit 127 may be configured to indicate a contiguous state or a non-contiguous state of a first PRP list 131 and a second PRP list 151 of a plurality of PRP lists 131, 151, 171. It may be noted that each of the plurality of PRP lists 131, 151, 171 comprise a designated bit 141, 161, and 181 respectively.

In detail, the host 101 may configure the designated bit 127 in the NVMe command 121 with a first predefined flag value for the contiguous state or a second predefined flag value for the non-contiguous state of the first PRP list 131 and the second PRP list 151.

For indicating the contiguous state of the first PRP list 131 and the second PRP list 151, the host 101 may configure the designated bit 127 in the NVMe command 121 with the first predefined flag value, e.g., 0 or 1. The rest of the PRP2 may store a memory address pointing to the first PRP list 131. The host 101 may configure the first entry to the second last entry in the first PRP list 131 to point to respective data buffer i.e., the first entry may point to a data buffer 133, the second entry may point to a data buffer 135, the third entry may point to a data buffer 137 and the like. Further, the host 101 may configure a pointer in the last entry of the first PRP list 131 to point a data buffer 139. In some example embodiments, the first predefined flag value may be 1 and the second predefined flag value may be 0. For instance, when the host 101 configures the designated bit 127 in the NVMe command 121 with the first predefined flag value, the first PRP list 131 and the second PRP list 151 are in contiguous state or contiguous in terms of memory address.

For indicating the non-contiguous state of the first PRP list 131 and the second PRP list 151, the host 101 may configure the designated bit 127 in the NVMe command 121 with the second predefined flag value. For instance, when the host 101 configures the designated bit 127 in the NVMe command 121 with the second predefined flag value, the first PRP list 131 and the second PRP list 151 are in non-contiguous state or not contiguous in terms of memory address. The rest of the PRP2 may store the memory address pointing to the first PRP list 131. The host 101 may configure the first entry to the second last entry in the first PRP list 131 to point to respective data buffer i.e., the first entry may point to the data buffer 133, the second entry may point to the data buffer 135, the third entry may point to the data buffer 137 and the like. Further, the host 101 may configure a pointer in the last entry of the first PRP list 131 to point the second PRP list 151.

Thereafter, the host 101 may configure the designated bit 141 of the last entry in the first PRP list (also, referred as a current PRP list) 131 of the plurality of PRP lists 131, 151, 171 to indicate the contiguous state or non-contiguous state of next two PRP lists (i.e., second PRP list and third PRP list) first subsequent PRP list 151 and second subsequent PRP list 171, respectively subsequent to the current PRP list 131, of the plurality of PRP lists 131, 151, 171. The designated bit 141 may be a single bit in the last entry in the current PRP list 131. In detail, the host 101 may configure the designated bit 141 of the last entry in the current PRP list 131 with the first predefined flag value for the contiguous state or the second predefined flag value for the non-contiguous state of the next two PRP lists first subsequent PRP list 151 and second subsequent PRP list 171 subsequent to the current PRP list 131.

For indicating the contiguous state of next two PRP lists 151, 171 subsequent to the current PRP list 131, the host 101 may configure the designated bit 141 of the last entry in the current PRP list 131 with the first predefined flag value. For instance, when the host 101 configures the designated bit 141 of the last entry in the current PRP list 131 with the first predefined flag value, the second PRP list 151 and the third PRP list 171 are in contiguous state or contiguous in terms of memory address. The rest of the last entry in the current PRP list 131 may store a memory address pointing to a data buffer 139. The host 101 may configure the first entry to the second last entry in the second PRP list 151 to point to respective data buffer i.e., the first entry may point to a data buffer 153, the second entry may point to a data buffer 155, the third entry may point to a data buffer 157 and the like. Further, the host 101 may configure a pointer in the last entry of the first subsequent PRP list (i.e., second PRP list) 151 of the next two PRP lists (i.e., second PRP list and third PRP list) 151, 171, subsequent to the current PRP list 131, to point to a user data buffer 159. Similarly, the host 101 may configure a pointer in the last entry of the second subsequent PRP list (i.e., third PRP list) 171 of the next two PRP lists (i.e., second PRP list and third PRP list) 151, 171, subsequent to the current PRP list which is the first subsequent PRP list 151, to point to a user data buffer 179.

For indicating the non-contiguous state of next two PRP lists, first subsequent PRP list 151, and second subsequent PRP list 171 subsequent to the current PRP list 131, the host 101 may configure the designated bit 141 of the last entry in the current PRP list 131 with the second predefined flag value. For instance, when the host 101 configures the designated bit 141 of the last entry in the current PRP list 131 with the second predefined flag value, the second PRP list 151 and the third PRP list 171 are in non-contiguous state or not contiguous in terms of memory address. The rest of the last entry in the current PRP list 131 may store the memory address pointing to the second PRP list 151. The host 101 may configure the first entry to the second last entry in the second PRP list 151 to point to respective data buffer i.e., the first entry may point to the data buffer 153, the second entry may point to the data buffer 155, the third entry may point to the data buffer 157 and the like. Further, the host 101 may configure a pointer in the last entry of a first subsequent PRP list 151 of the next two PRP lists first subsequent PRP list 151 and second subsequent PRP list 171, subsequent to the current PRP list 131, to point to the second subsequent PRP list 171 of the next two PRP lists 151, 171.

Upon configuration of the designated bit 127 in the NVMe command 121 and the designated bit 141 of the last entry in the current PRP list 131, the host 101 may submit the NVMe command 121 for the controller 105 to perform data transfer in the SSD.

The controller 105 may access the NVMe command 121 submitted by the host 101. In some example embodiments, the controller 105 may process the first PRP list 131 and the second PRP list 151 of the plurality of PRP lists 131, 151, 171 based on a configuration of the designated bit 127 in the NVMe command 121. The designated bit 127 may indicate a contiguous state or a non-contiguous state of the first PRP list 131 and the second PRP list 151. The controller 105 may fetch a user data from respective data buffer indicated by a pointer in the first entry to the second last entry in the first PRP list 131 i.e., the first entry may point to the data buffer 133, the second entry may point to the data buffer 135, the third entry may point to the data buffer 137 and the like. When the designated bit 127 in the NVMe command 121 is the first predefined flag value, the controller 105 may fetch a user data from a data buffer 139 indicated by a pointer in the last entry in the first PRP list 131. Thereafter, the controller 105 may calculate a memory address of the second PRP list 151 of the plurality of PRP lists 131, 151, 171 based on a memory address of the last entry of the first PRP list 131 and an offset. In some example embodiments, the offset may be a PRP size value or maximum memory page size value. Based on the calculation, the controller 105 may fetch a data from respective data buffer 153 by accessing the second PRP list 151.

When the designated bit 127 in the NVMe command 121 is the second predefined flag value, the controller 105 may fetch data from respective data buffer 133 by accessing the first PRP list 131 indicated by a pointer in the PRP2 in the NVMe command. The controller 105 may fetch a user data from respective data buffer indicated by a pointer in the first entry to the second last entry in the first PRP list 131 i.e., the first entry may point to the data buffer 133, the second entry may point to the data buffer 135, the third entry may point to the data buffer 137 and the like. Thereafter, the controller 105 may fetch data from respective data buffer 153 by accessing the second PRP list 151 indicated by a pointer in the last entry in the first PRP list 131.

Thereafter, the controller 105 may process next two PRP lists, first subsequent PRP list 151 and second subsequent PRP list 171, subsequent to a current PRP list 131, of the plurality of PRP lists 131, 151, 171 based on the configuration of the designated bit 141 of a last entry in the current PRP list 131 of the plurality of PRP lists 131, 151, 171. The designated bit 141 may indicate the contiguous state or the non-contiguous state of the next two PRP lists 151, 171, subsequent to the current PRP list 131.

The controller 105 may fetch a user data from respective data buffer indicated by a pointer in the first entry to the second last entry in the second PRP list 151 i.e., the first entry may point to the data buffer 153, the second entry may point to the data buffer 155, the third entry may point to the data buffer 157 and the like. When the designated bit 141 of the last entry in the current PRP list 131 is a first predefined flag value, the controller 105 may fetch a user data from a data buffer 159 indicated by a pointer in the last entry in a first subsequent PRP list 151 of the next two PRP lists 151, 171. Thereafter, the controller 105 may calculate a memory address of a second subsequent PRP list (i.e., third PRP list) 171 of the next two PRP lists 151, 171 based on a memory address of the last entry of the first subsequent PRP list 151 of the next two PRP lists 151, 171 and an offset. Based on the calculation, the controller 105 may fetch a data from respective data buffer 173 (or data buffer 175 or data buffer 177) by accessing the second subsequent PRP list 171 of the next two PRP lists 151, 171.

When the designated bit 141 of the last entry in the current PRP list 131 is the second predefined flag value, the controller 105 may fetch data from respective data buffer 153 by accessing the second PRP list 151 indicated by a pointer in the last entry in the first PRP list 131. The controller 105 may fetch a user data from respective data buffer indicated by a pointer in the first entry to the second last entry in the second PRP list 151 i.e., the first entry may point to the data buffer 153, the second entry may point to the data buffer 155, the third entry may point to the data buffer 157 and the like. Thereafter, the controller 105 may fetch data from respective data buffer 173 by accessing the third PRP list 171 indicated by a pointer in the last entry in the second PRP list 151.

With reference to FIGS. 1C to 1E, three PRP lists i.e., the first PRP list 131, the second PRP list 151, and the third PRP list 171 were considered for sake of explaining the operation of performing data transfer in the SSD and should not be construed as a limitation of the present disclosure. The number of PRP lists required for performing data transfer in the SSD depends on amount of data to be transferred to the SSD.

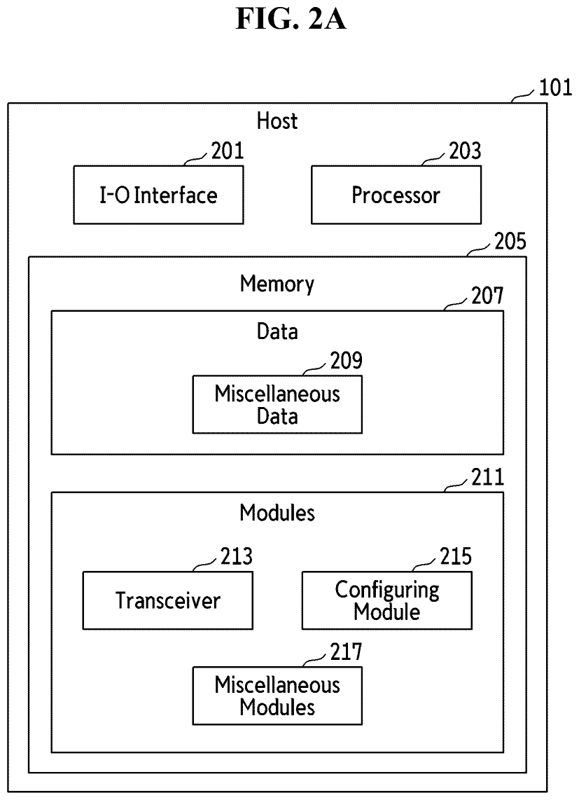

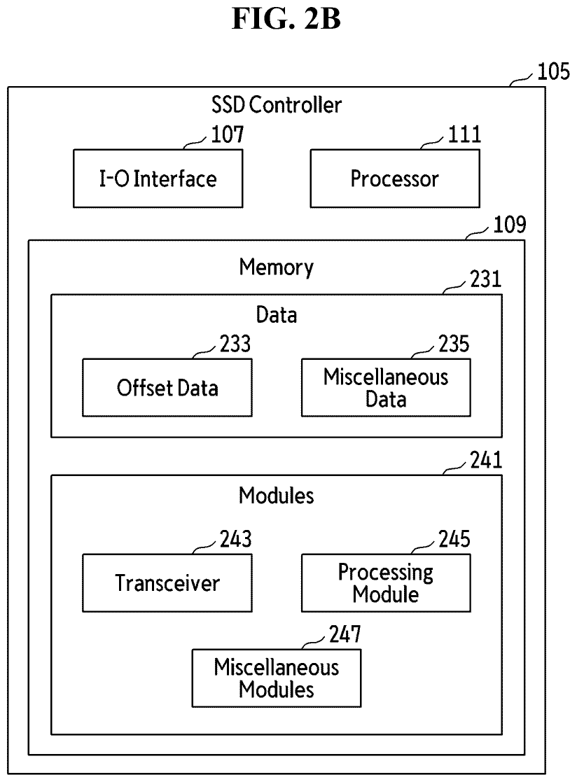

FIG. 2A shows a detailed block diagram of a host in accordance with some example embodiments of the present disclosure.

The host device 101 may include an I-O interface 201, a processor 203 (may include one or more processors working collectively or individually), and a memory 205. The I-O interface 201 may be configured to send the I-O (or I-O request) to the controller 105 of the SSD. The I-O (or I-O request) may be a read request (also, referred as a data read request) or a write request (also, referred as a data write request). The I-O interface 201 may employ a wired communication protocol/method.

The processor 203 may include at least one data processor for performing data transfer in the SSD. The processor 203 may include specialized processing units such as integrated system (bus) controllers, memory management control units, floating point units, graphics processing units, digital signal processing units, etc.

The memory 205 may be communicatively coupled to the processor 203 of the host 101. The memory 205, also, stores controller-executable instructions which may cause the processor 203 to execute the instructions for performing data transfer in the SSD. The memory 205 includes, without limitation, memory drives, removable disc drives, etc.

In some example embodiments, data 207 and one or more modules 211 may be stored within the memory 205 (for example within a memory array). The data 207 may include, for example, miscellaneous data 209.

The miscellaneous data 209 may include data, including at least one of meta data, and temporary files, generated by the one or more modules 211 for performing the various functions of the host 101.

In some example embodiments, the data 207 in the memory 205 may be processed by the one or more modules 211 present within the memory 205 of the host 101. In some example embodiments, the one or more modules 211 are implemented as dedicated hardware units (for example, circuits or circuitry). As described herein, any electronic devices and/or portions thereof according to any of the example embodiments may include, may be included in, and/or may be implemented by one or more instances of processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, Application-Specific Integrated Circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a Dynamic Random-Access Memory (DRAM) device, storing a program of instructions, and a processor (e.g., CPU) configured to execute the program of instructions to implement the functionality and/or methods performed by some or all of any devices, systems, modules, units, controllers, circuits, architectures, and/or portions thereof according to any of the example embodiments, and/or any portions thereof.

In some example embodiments, the one or more modules 211 may be communicatively coupled to the processor 203 for performing one or more functions of the host 101. The one or more modules 211 when configured with the functionality defined in the present disclosure results in a novel hardware. In some example embodiments, the processor 203 (also, referred as controller) may include the one or more modules 211.

In some example embodiments, the one or more modules 211 include, but are not limited to, a transceiver 213, and/or a configuring module 215. The one or more modules 211 may further include miscellaneous modules 217 to perform various miscellaneous functionalities of the host 101.

In some example embodiments, the transceiver 213 may submit the NVMe command 121 for a controller 105 of the SSD to perform data transfer in the SSD upon the configuration by the configuring module 215.

In some example embodiments, the configuring module 215 may configure a designated bit 127 in the NVMe command 121 to indicate a contiguous state or a non-contiguous state of a first PRP list 131 and a second PRP list 151 of a plurality of PRP lists 131, 151, 171. In detail, the configuring module 215 may configure the designated bit 127 in the NVMe command 121 with a first predefined flag value for the contiguous state or a second predefined flag value for the non-contiguous state of the first PRP list 131 and the second PRP list 151. For indicating the contiguous state of the first PRP list 131 and the second PRP list 151, the configuring module 215 may configure the designated bit 127 in the NVMe command 121 with a first predefined flag value, and a pointer in the last entry of the first PRP list 131 to point a user data buffer 139.

Thereafter, the configuring module 215 may configure the designated bit 141 of a last entry in a current PRP list 131 of the plurality of PRP lists 131, 151, 171 to indicate the contiguous state or non-contiguous state of next two PRP lists, first subsequent PRP list 151 and second subsequent PRP list 171, subsequent to the current PRP list 131, of the plurality of PRP lists 131, 151, 171. In detail, the configuring module 215 may configure the designated bit 141 of a last entry in the current PRP list 131 with a first predefined flag value for the contiguous state or a second predefined flag value for the non-contiguous state of the next two PRP lists first subsequent PRP list 151 and second subsequent PRP list 171 subsequent to the current PRP list 131. For indicating the contiguous state of next two PRP lists first subsequent PRP list 151 and second subsequent PRP list 171 subsequent to the current PRP list 131, the configuring module 215 may configure the designated bit 141 of the last entry in the current PRP list 131 with the first predefined flag value and a pointer in the last entry of a first subsequent PRP list 151 of the next two PRP lists first subsequent PRP list 151 and second subsequent PRP list 171 subsequent to the current PRP list 131, to point to a user data buffer 159.

FIG. 2B shows a detailed block diagram of a controller of an SSD in accordance with some example embodiments of the present disclosure.

The controller 105 of an SSD (also, referred as an SSD controller), in addition to the I-O interface 107 and the processor 111 described above with reference to FIG. 1A, may include data 231 and one or more modules 241. In some example embodiments, the data 231 may be stored within the memory 109 (for example within a memory array). The data 231 may include, for example, offset data 233, and miscellaneous data 235.

The offset data 233 may store a PRP size value or maximum memory page size value to be used as offset.

The miscellaneous data 235 may include data, including at least one of meta data, and temporary files, generated by the one or more modules 241 for performing the various functions of the controller 105.

In some example embodiments, the data 231 in the memory 109 may be processed by the one or more modules 241 present within the memory 109 of the controller 105. In some example embodiments, the one or more modules 241 are implemented as dedicated hardware units (for example, circuits or circuitry). As described herein, any electronic devices and/or portions thereof according to any of the example embodiments may include, may be included in, and/or may be implemented by one or more instances of processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, Application-Specific Integrated Circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a Dynamic Random-Access Memory (DRAM) device, storing a program of instructions, and a processor (e.g., CPU) configured to execute the program of instructions to implement the functionality and/or methods performed by some or all of any devices, systems, modules, units, controllers, circuits, architectures, and/or portions thereof according to any of the example embodiments, and/or any portions thereof.

In some example embodiments, the one or more modules 241 may be communicatively coupled to the processor 111 for performing one or more functions of the controller 105. The one or more modules 241 when configured with the functionality defined in the present disclosure results in a novel hardware. In some example embodiments, the processor 111 may include the one or more modules 241.

In some example embodiments, the one or more modules 241 include, but are not limited to, a transceiver 243, and/or a processing module 245. The one or more modules 241 may further include miscellaneous modules 247 to perform various miscellaneous functionalities of the controller 105.

In some example embodiments, the transceiver 243 may access the NVMe command 121 submitted by the host 101.

In some example embodiments, the processing module 245 may process a first PRP list 131 and a second PRP list 151 of a plurality of PRP lists 131, 151, 171 based on a configuration of a designated bit 127 in the NVMe command 121 indicating a contiguous state or a non-contiguous state of the first PRP list 131 and the second PRP list 151. In detail, when the designated bit 127 in the NVMe command 121 is a first predefined flag value, the processing module 245 may fetch a user data from a data buffer 139 indicated by a pointer in a last entry in the first PRP list 131. The processing module 245 may calculate a memory address of second PRP list 151 of the plurality of PRP lists 131, 151, 171 based on a memory address of the last entry of the first PRP list 131 and an offset. Based on the calculation, the processing module 245 may fetch a data from respective data buffer 153 by accessing the second PRP list 151.

Thereafter, the processing module 245 may process next two PRP lists, first subsequent PRP list 151 and second subsequent PRP list 171 subsequent to a current PRP list 131, of the plurality of PRP lists 131, 151, 171 based on the configuration of the designated bit 141 of a last entry in the current PRP list 131 of the plurality of PRP lists 131, 151, 171 indicating the contiguous state or the non-contiguous state of the next two PRP lists 151, 171, subsequent to the current PRP list 131. In detail, when the designated bit 141 of the last entry in the current PRP list 131 is a first predefined flag value, the processing module 245 may fetch a user data from a data buffer 159 indicated by a pointer in the last entry in a first 151 of the next two PRP lists, first subsequent PRP list 151 and second subsequent PRP list 171. The processing module 245 may calculate a memory address of a second 171 of the next two PRP lists, first subsequent PRP list 151 and second subsequent PRP list 171 based on a memory address of the last entry of the first 151 of the next two PRP lists, first subsequent PRP list 151 and second subsequent PRP list 171 and an offset. The processing module 245 may fetch a data from respective data buffer 173 by accessing the second 171 of the next two PRP lists, first subsequent PRP list 151 and second subsequent PRP list 171 based on the calculation.

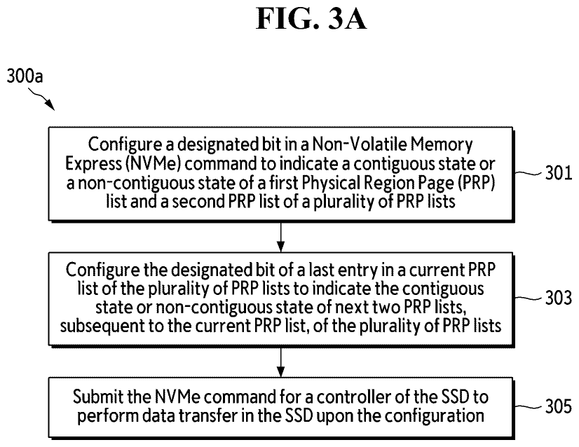

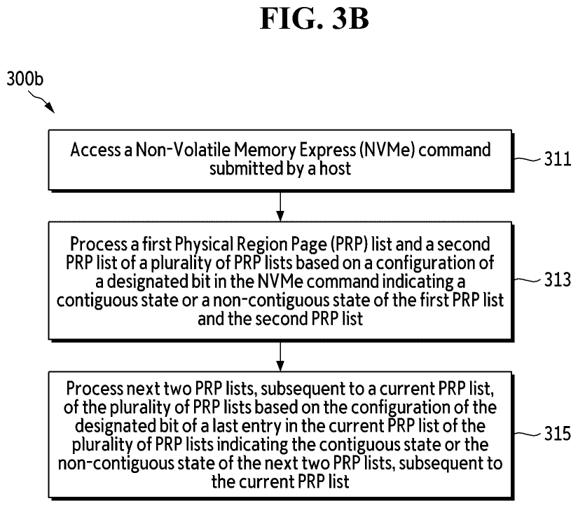

FIGS. 3A and 3B illustrate flowcharts showing methods for performing data transfer in an SSD in accordance with some example embodiments of the present disclosure.

As illustrated in FIGS. 3A and 3B, the methods 300a and 300b, respectively, include operations for performing data transfer in the SSD. The methods 300a and 300b may be described in the general context of computer executable instructions. Generally, computer executable instructions can include routines, programs, objects, components, data structures, procedures, units, and/or functions, which perform particular functions or implement particular abstract data types.

The order in which the methods 300a and 300b are described is not intended to be construed as a limitation, and any number of the described method operations can be combined in any order to implement the methods. Additionally, individual operations may be deleted from the methods without departing from the scope of the subject matter described herein. Furthermore, the methods can be implemented in any suitable hardware, software, firmware, or combination thereof.

The following operations are performed by the host 101.

At operation 301, the configuring module 215 of the host 101 may configure a designated bit 127 in a NVMe command 121 to indicate a contiguous state or a non-contiguous state of a first PRP list 131 and a second PRP list 151 of a plurality of PRP lists 131, 151, 171.

At operation 303, the configuring module 215 of the host 101 may configure the designated bit 141 of a last entry in a current PRP list 131 of the plurality of PRP lists 131, 151, 171 to indicate the contiguous state or non-contiguous state of next two PRP lists 151, 171, subsequent to the current PRP list 131, of the plurality of PRP lists 131, 151, 171.

At operation 305, the transceiver 213 of the host 101 may submit the NVMe command 121 for a controller 105 of the SSD to perform data transfer in the SSD upon the configuration.

The following operations are performed by the controller 105 of the SSD.

At operation 311, the controller 105 of the SSD may access a NVMe command 121 submitted by a host 101.

At operation 313, the controller 105 of the SSD may process a first PRP list 131 and a second PRP list 151 of a plurality of PRP lists 131, 151, 171 based on a configuration of a designated bit 127 in the NVMe command 121 indicating a contiguous state or a non-contiguous state of the first PRP list 131 and the second PRP list 151.

At operation 315, the controller 105 of the SSD may process next two PRP lists 151, 171, subsequent to a current PRP list 131, of the plurality of PRP lists 131, 151, 171 based on the configuration of the designated bit 141 of a last entry in the current PRP list 131 of the plurality of PRP lists 131, 151, 171 indicating the contiguous state or the non-contiguous state of the next two PRP lists 151, 171, subsequent to the current PRP list 131.

Some technical advantages of the present disclosure are given below:

The present disclosure uses a designated bit in a NVMe command and a designated bit of a last entry in a PRP list to indicate a contiguous state or non-contiguous state of next two PRP lists. This approach (1) avoids reading extra data to process next PRP list, and (2) avoids creating bubbles or gaps in data transfer by informing the controller that the subsequent PRP list is contiguous. As a consequence, this approach of using a designated bit to indicate a contiguous state or non-contiguous state of next two PRP lists improves the performance of the controller significantly.

Some of the clauses are mentioned below.
[1]: A method for performing data transfer in a Solid State Drive (SSD), comprising:
configuring, by a host, a designated bit in a Non-Volatile Memory Express (NVMe) command to indicate a contiguous state or a non-contiguous state of a first Physical Region Page (PRP) list and a second PRP list of a plurality of PRP lists; and
submitting, by the host, the NVMe command for a controller of the SSD to perform data transfer in the SSD upon the configuration.
[2]: The method as described in [1], wherein indicating the contiguous state or the non-contiguous state of the first PRP list and the second PRP list of the plurality of PRP lists comprises:
configuring, by the host, the designated bit in the NVMe command with a first predefined flag value for the contiguous state or a second predefined flag value for the non-contiguous state of the first PRP list and the second PRP list.
[3]: The method as described in [1], wherein indicating the contiguous state of the first PRP list and the second PRP list comprises:
configuring, by the host, the designated bit in the NVMe command set with a first predefined flag value; and
configuring, by the host, a pointer in the last entry of the first PRP list to point a user data buffer.
[4]: The method as described in [1], prior to submitting the NVMe command for the controller of the SSD to perform the data transfer in the SSD, the method comprising:
configuring, by the host, the designated bit of a last entry in a current PRP list of the plurality of PRP lists to indicate the contiguous state or non-contiguous state of next two PRP lists, subsequent to the current PRP list, of the plurality of PRP lists.
[5]: The method as described in [4], wherein indicating the contiguous state or the non-contiguous state of the next two PRP lists, subsequent to the current PRP list, of the plurality of PRP lists comprises:
configuring, by the host, the designated bit of a last entry in the current PRP list with a first predefined flag value for the contiguous state or a second predefined flag value for the non-contiguous state of the next two PRP lists subsequent to the current PRP list.
[6]: The method as described in [5], wherein indicating the contiguous state of next two PRP lists subsequent to the current PRP list comprises:
configuring, by the host, the designated bit of the last entry in the current PRP list with the first predefined flag value; and
configuring, by the host, a pointer in the last entry of a first of the next two PRP lists, subsequent to the current PRP list, to point to a user data buffer.
[7]: A method for performing data transfer in a Solid State Drive (SSD), comprising:
accessing, by a controller of an SSD, a Non-Volatile Memory Express (NVMe) command submitted by a host; and
processing, by the controller, a first Physical Region Page (PRP) list and a second PRP list of a plurality of PRP lists based on a configuration of a designated bit in the NVMe command indicating a contiguous state or a non-contiguous state of the first PRP list and the second PRP list.
[8]: The method as described in [7], further comprising:
processing, by the controller, next two PRP lists, subsequent to a current PRP list, of the plurality of PRP lists based on the configuration of the designated bit of a last entry in the current PRP list of the plurality of PRP lists indicating the contiguous state or the non-contiguous state of the next two PRP lists, subsequent to the current PRP list.
[9]: The method as described in [7], wherein processing the first PRP list and the second PRP list of the plurality of PRP lists based on the configuration of the designated bit in the NVMe command indicating the contiguous state or the non-contiguous state of the first PRP list and the second PRP list comprising:
when the designated bit in the NVMe command is a first predefined flag value,
fetching by the controller, a user data from a data buffer indicated by a pointer in a last entry in the first PRP list;
calculating, by the controller, a memory address of second PRP list of the plurality of PRP lists based on a memory address of the last entry of the first PRP list and an offset; and
fetching, by the controller, a data from respective data buffer by accessing the second PRP list based on the calculation.
[10]: The method as described in [8], wherein processing the next two PRP lists, subsequent to the current PRP list, of the plurality of PRP lists based on the configuration of the designated bit of the last entry in the current PRP list indicating the contiguous state or the non-contiguous state of the next two PRP lists, subsequent to a current PRP list comprising:
when the designated bit of the last entry in the current PRP list is a first predefined flag value,
fetching, by the controller, a user data from a data buffer indicated by a pointer in the last entry in a first of the next two PRP lists;
calculating, by the controller, a memory address of a second of the next two PRP lists based on a memory address of the last entry of the first of the next two PRP lists and an offset; and
fetching, by the controller, a data from respective data buffer by accessing the second of the next two PRP lists based on the calculation.
[11]: A host for performing data transfer in a Solid State Drive (SSD), comprising:
a processor; and
a memory communicatively coupled to the processor, wherein the memory stores processor-executable instructions, which on execution, cause the processor to:
configure a designated bit in a Non-Volatile Memory Express (NVMe) command to indicate a contiguous state or a non-contiguous state of a first Physical Region Page (PRP) list and a second PRP list of a plurality of PRP lists; and
submit the NVMe command for a controller of the SSD to perform data transfer in the SSD upon the configuration.
[12]: The host as described in [11], wherein for indicating the contiguous state or the non-contiguous state of the first PRP list and the second PRP list of the plurality of PRP lists, the processor is configured to:
configure the designated bit in the NVMe command with a first predefined flag value for the contiguous state or a second predefined flag value for the non-contiguous state of the first PRP list and the second PRP list.
[13]: The host as described in [11], wherein for indicating the contiguous state of the first PRP list and the second PRP list, the processor is configured to:
configure the designated bit in the NVMe command set with a first predefined flag value; and
configure a pointer in the last entry of the first PRP list to point a user data buffer.
[14]: The host as described in [11], prior to submitting the NVMe command for the controller of the SSD to perform the data transfer in the SSD, the processor is configured to:
configure the designated bit of a last entry in a current PRP list of the plurality of PRP lists to indicate the contiguous state or non-contiguous state of next two PRP lists, subsequent to the current PRP list, of the plurality of PRP lists.
[15]: The host as described in [14], wherein for indicating the contiguous state or the non-contiguous state of the next two PRP lists, subsequent to the current PRP list, of the plurality of PRP lists, the processor is configured to:
configure the designated bit of the last entry in the current PRP list with a first predefined flag value for the contiguous state or a second predefined flag value for the non-contiguous state of the next two PRP lists subsequent to the current PRP list.
[16]: The host as described in [15], wherein for indicating the contiguous state of next two PRP lists subsequent to the current PRP list, the processor is configured to:
configure the designated bit of the last entry in the current PRP list with the first predefined flag value; and
configure a pointer in the last entry of a first of the next two PRP lists, subsequent to the current PRP list, to point to a user data buffer.
[17]: A Solid State Drive (SSD) for performing data transfer in the SSD, comprising:
a controller configured to:
access a Non-Volatile Memory Express (NVMe) command submitted by a host; and
process a first Physical Region Page (PRP) list and a second PRP list of a plurality of PRP lists based on a configuration of a designated bit in the NVMe command indicating a contiguous state or a non-contiguous state of the first PRP list and the second PRP list.
[18]: The SSD as described in [17], wherein the controller is configured to:
process next two PRP lists, subsequent to a current PRP list, of the plurality of PRP lists based on the configuration of the designated bit of a last entry in the current PRP list of the plurality of PRP lists indicating the contiguous state or the non-contiguous state of the next two PRP lists, subsequent to the current PRP list.
[19]: The SSD as described in [17], wherein for processing the first PRP list and the second PRP list of the plurality of PRP lists based on the configuration of the designated bit in the NVMe command indicating the contiguous state or the non-contiguous state of the first PRP list and the second PRP list, the controller is configured to:
when the designated bit in the NVMe command is a first predefined flag value,
fetch a user data from a data buffer indicated by a pointer in a last entry in the first PRP list;
calculate a memory address of second PRP list of the plurality of PRP lists based on a memory address of the last entry of the first PRP list and an offset; and
fetch a data from respective data buffer by accessing the second PRP list based on the calculation.
[20]: The SSD as described in [18], wherein for processing the next two PRP lists, subsequent to the current PRP list, of the plurality of PRP lists based on the configuration of the designated bit of the last entry in the current PRP list indicating the contiguous state or the non-contiguous state of the next two PRP lists, the controller is configured to:
when the designated bit of the last entry in the current PRP list is a first predefined flag value,
fetch a user data from a data buffer indicated by a pointer in the last entry in a first of the next two PRP lists;
calculate a memory address of a second of the next two PRP lists based on a memory address of the last entry of the first of the next two PRP lists and an offset; and
fetch a data from respective data buffer by accessing the second of the next two PRP lists based on the calculation.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (for example, hard disk drives, floppy disks, tape, etc.), optical storage (CD-ROMs, DVDs, optical disks, etc.), volatile and non-volatile memory devices (for example, EEPROMs, ROMs, PROMs, RAMs, DRAMs, SRAMs, Flash Memory, firmware, programmable logic, etc.), etc. Further, non-transitory computer-readable media include all computer-readable media except for a transitory. The code implementing the described operations may further be implemented in hardware logic (for example, an integrated circuit chip, Programmable Gate Array (PGA), ASIC, etc.).

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of some example embodiments with several components in communication with each other does not imply that all such components are required. On the contrary, a variety of optional components are described to illustrate the wide variety of possible embodiments of the disclosure.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

The illustrated operations of FIGS. 3A and 3B show certain events occurring in a certain order. In alternative example embodiments, certain operations may be performed in a different order, modified or removed. Moreover, operations may be added to the above-described logic and still conform to the described example embodiments. Further, operations described herein may occur sequentially or certain operations may be processed in parallel. Yet further, operations may be performed by a single processing unit or by distributed processing units.

According to some embodiments of the present disclosure, an SSD for performing data transfer in the SSD.

The SSD may comprise, a controller may access a Non-Volatile Memory Express (NVMe) command transmitted by a host, and process a first Physical Region Page (PRP) list and a second PRP list based on a configuration of a designated bit in the NVMe command indicating a contiguous state or a non-contiguous state of the first PRP list and the second PRP list, the first PRP list and the second PRP list being among of a plurality of PRP lists.

The controller may be configured to process next two PRP lists subsequent to a current PRP list based on the configuration of the designated bit of a last entry in the current PRP list indicating the contiguous state or the non-contiguous state of the next two PRP lists, the current PRP list and the next two PRP lists subsequent to the current PRP list being among the plurality of PRP lists.

For the processing the first PRP list and the second PRP list of the plurality of PRP lists based on the configuration of the designated bit in the NVMe command, the controller may be configured to fetch user data from a data buffer indicated by a pointer in a last entry in the first PRP list based on the designated bit in the NVMe command being a first predefined flag value. The controller may further be configured to calculate a memory address of second PRP list of the plurality of PRP lists based on a memory address of the last entry of the first PRP list and an offset, and to fetch a data from the data buffer by accessing the second PRP list based on the calculation.

For the processing the next two PRP lists based on the configuration of the designated bit of the last entry in the current PRP list, the controller may be configured as follows. Based on the designated bit of the last entry in the current PRP list is a first predefined flag value, the controller may fetch user data from a data buffer indicated by a pointer in the last entry in a first subsequent PRP list of the next two PRP lists, calculate a memory address of a second subsequent PRP list of the next two PRP lists based on a memory address of the last entry of the first subsequent PRP list of the next two PRP lists and an offset, and fetch a data from respective data buffer by accessing the second subsequent PRP list of the next two PRP lists based on the calculation.

Finally, the language used in the specification has been principally selected for readability and instructional purposes, and it may not have been selected to delineate or circumscribe the subject matter. It is therefore intended that the scope of the disclosure be limited not by this detailed description, but rather by any claims that issue on an application based here on. Accordingly, the disclosure of some example embodiments of the disclosure is intended to be illustrative, but not limiting, of the scope of the disclosure, which are set forth in the following claims.

While various aspects and embodiments have been disclosed herein, other aspects and embodiments will be apparent to those of ordinary skill in the art. The various aspects and embodiments disclosed herein are for purposes of illustration and are not intended to be limiting, with the true scope being indicated by the following claims.

What is claimed is:

1. A method for data transfer to and from a Solid State Drive (SSD), the method being executed by one or more processors, the method comprising:
configuring, by a host, a designated bit in a Non-Volatile Memory Express (NVMe) command to indicate a contiguous state or a non-contiguous state of a first Physical Region Page (PRP) list and a second PRP list among a plurality of PRP lists; and
transmitting, by the host, the NVMe command for a controller of the SSD to perform data transfer in the SSD based on the designated bit.

2. The method of claim 1, wherein the configuring the designated bit comprises:
configuring, by the host, the designated bit in the NVMe command with a first predefined flag value for the contiguous state of the first PRP list and the second PRP list; or
configuring, by the host, the designated bit in the NVMe command with a second predefined flag value for the non-contiguous state of the first PRP list and the second PRP list.

3. The method of claim 1, wherein the indicating the contiguous state of the first PRP list and the second PRP list comprises:
configuring, by the host, the designated bit in the NVMe command set with a first predefined flag value; and
configuring, by the host, a pointer in a last entry of the first PRP list to point a user data buffer.

4. The method of claim 1, prior to the transmitting the NVMe command, the method comprises:
configuring, by the host, the designated bit of a last entry in a current PRP list to indicate the contiguous state or the non-contiguous state of next two PRP lists that are subsequent to the current PRP list, the current PRP list and the next two PRP lists subsequent to the current PRP list are among the plurality of PRP lists.

5. The method of claim 4, wherein the configuring the designated bit of the last entry in the current PRP list comprises:
configuring, by the host, the designated bit of the last entry in the current PRP list with a first predefined flag value for the contiguous state of the next two PRP lists subsequent to the current PRP list; or
configuring, by the host, the designated bit of the last entry in the current PRP list with a second predefined flag value for the non-contiguous state of the next two PRP lists subsequent to the current PRP list.

6. The method of claim 5, wherein the indicating the contiguous state of next two PRP lists subsequent to the current PRP list comprises:
based on the next two PRP lists subsequent to the current PRP list being in the contiguous state, configuring, by the host, the designated bit of the last entry in the current PRP list with the first predefined flag value; and
based on at least one of the next two PRP lists subsequent to the current PRP list being in the non-contiguous state, configuring, by the host, a pointer in the last entry of a first subsequent PRP list of the next two PRP lists to point to a user data buffer.

7. A method for performing data transfer to and from a Solid State Drive (SSD), the method being executed by a controller of the SSD, the method comprising:
accessing, by the controller of the SSD, a Non-Volatile Memory Express (NVMe) command transmitted by a host; and
processing, by the controller, a first Physical Region Page (PRP) list and a second PRP list based on a configuration of a designated bit in the NVMe command indicating a contiguous state or a non-contiguous state of the first PRP list and the second PRP list, the first PRP list and the second PRP list being among a plurality of PRP lists.

8. The method of claim 7, further comprising:
processing, by the controller, next two PRP lists subsequent to a current PRP list based on the configuration of the designated bit of a last entry in the current PRP list indicating the contiguous state or the non-contiguous state of the next two PRP lists, the current PRP list and the next two PRP lists subsequent to the current PRP list being among the plurality of PRP lists.

9. The method of claim 7, wherein the processing the first PRP list and the second PRP list of the plurality of PRP lists based on the configuration of the designated bit in the NVMe command comprises:
based on the designated bit in the NVMe command being a first predefined flag value, fetching by the controller, user data from a data buffer indicated by a pointer in a last entry in the first PRP list;
calculating, by the controller, a memory address of second PRP list of the plurality of PRP lists based on a memory address of the last entry of the first PRP list and an offset; and
fetching, by the controller, a data from the data buffer by accessing the second PRP list based on the calculation.

10. The method of claim 8, wherein the processing the next two PRP lists based on the configuration of the designated bit of the last entry in the current PRP list comprises:
based on the designated bit of the last entry in the current PRP list being a first predefined flag value, fetching, by the controller, user data from a data buffer indicated by a pointer in the last entry in a first subsequent PRP list of the next two PRP lists;
calculating, by the controller, a memory address of a second subsequent PRP list of the next two PRP lists based on a memory address of the last entry of the first subsequent PRP list of the next two PRP lists and an offset; and
fetching, by the controller, a data from respective data buffer by accessing the second subsequent PRP list of the next two PRP lists based on the calculation.

11. A host for performing data transfer to and from a Solid State Drive (SSD), comprising:
at least one processor; and
a memory communicatively coupled to the at least one processor, wherein the memory stores processor-executable instructions, which on execution, cause the at least one processor to:
configure a designated bit in a Non-Volatile Memory Express (NVMe) command to indicate a contiguous state or a non-contiguous state of a first Physical Region Page (PRP) list and a second PRP list among a plurality of PRP lists; and
transmit the NVMe command for a controller of the SSD to perform data transfer in the SSD based on the designated bit.

12. The host of claim 11, wherein for the configuring of the designated bit, the at least one processor is configured to:
configure the designated bit in the NVMe command with a first predefined flag value for the contiguous state of the first PRP list and the second PRP list; or
configure the designated bit in the NVMe command with a second predefined flag value for the non-contiguous state of the first PRP list and the second PRP list.

13. The host of claim 11, wherein for the indicating the contiguous state of the first PRP list and the second PRP list, the at least one processor is configured to:
configure the designated bit in the NVMe command set with a first predefined flag value; and
configure a pointer in a last entry of the first PRP list to point a user data buffer.

14. The host of claim 11, prior to the transmitting the NVMe command, the at least one processor is configured to:
configure the designated bit of a last entry in a current PRP list of the plurality of PRP lists to indicate the contiguous state or the non-contiguous state of next two PRP lists that are subsequent to the current PRP list, the current PRP list and the next two PRP lists subsequent to the current PRP list are among the plurality of PRP lists.

15. The host of claim 14, wherein for the configuring the designated bit of the last entry in the current PRP list, the at least one processor is configured to:
configure the designated bit of the last entry in the current PRP list with a first predefined flag value for the contiguous state of the next two PRP lists subsequent to the current PRP list; or
configure the designated bit of the last entry in the current PRP list with a second predefined flag value for the non-contiguous state of the next two PRP lists subsequent to the current PRP list.

16. The host of claim 15, wherein for the indicating the contiguous state of next two PRP lists subsequent to the current PRP list, the at least one processor is configured to:
based on the next two PRP lists subsequent to the current PRP list being in the contiguous state, configure the designated bit of the last entry in the current PRP list with the first predefined flag value; and
based on at least one of the next two PRP lists subsequent to the current PRP list being in the non-contiguous state, configure a pointer in the last entry of a first subsequent PRP list of the next two PRP lists to point to a user data buffer.
